(19) United States
(12) Patent Application Publication
(10) Pub. No.: US 2004/0047840 A1
(43) Pub. Date: Mar. 11, 2004

(54) Control agents

(76) Inventors: David Harper, Bedfordshire (GB); Christina Sommerville, Stirling (GB)

Correspondence Address: NIXON & VANDERHYE, PC, 1100 N GLEBE ROAD, 8TH FLOOR, ARLINGTON, VA, 22201-4714, US

(21) Appl. No.: 10/466,211

(22) PCT Filed: Jan. 11, 2002
(86) PCT No.: PCT/GB02/00134

(30) Foreign Application Priority Data
Jan. 13, 2001 (GB) 0100929.9
Aug. 22, 2001 (GB) 0120430.4

(51) Int. Cl. A01N 63/00; A01N 65/00

(52) U.S. Cl. 424/93.4; 424/93.6; 424/93.7

(57) ABSTRACT

The present invention relates to the development of novel agents for the control of sea lice. The invention provides the use of a microbiological agent other than a fungus for the manufacture of a biological control agent for treating or preventing sea louse infestation.

### FIELD OF THE INVENTION

The present invention relates to the development of novel agents for the control of sea lice.

### BACKGROUND OF THE INVENTION

Fish farms are an increasingly important source of food throughout the world. In such farms fish are kept in tanks or in netted enclosures at very high densities. As with other methods of intensive rearing, this can lead to health problems for the captive animals.

Sea lice are parasitic copepods that infest both wild and farmed fish. Numbers of sea lice on wild fish are relatively low and the consequent damage is limited. In contrast, among farmed fish the number of sea lice is much higher and fish can be severely damaged. Among farmed salmon, such damage can result in losses in excess of 10% of total production.

Sea louse infestation is a serious problem for commercial salmon farming throughout the Northern hemisphere. Sea lice are crustaceans, falling within the family Caligidae. While there are over 400 members of the family Caligidae, only a very few of these cause infestations in fish farms. Chief among these are Lepeophtheirus salmonis and Caligus elongates (Costello, 1993; Jackson & Minchin, 1993). Control of these infestations is of limited efficacy and uses a combination of management practices such as single year stocking, fallowing and, most commonly, the use of chemotherapeutants such as ivermectin and dichlorvos.

Chemotherapeutants can be effective and represent the most commonly used option, but there are major disadvantages which limit their use. Environmental damage, in particular toxicity to non-target species, has resulted in their use under limited licences. Further limitations on the use of chemotherapeutants arises from the possibility of toxicity to consumers as a result of residues in the treated fish. Consumer resistance to the use of such chemical agents is increasing along with increasing evidence that low residue levels can have harmful effects. It is likely that the use of chemotherapeutants will be limited more strictly in future, resulting in a real gap in control of this damaging infestation.

In addition to the above problems, the development of resistance to chemical agents by any pest so controlled is well established. Alternative approaches such as the use of hydrogen peroxide are of very limited efficacy.

Biological approaches have been evaluated, but these have concentrated on the use of predator fish such as cleaner wrasse, which prey upon and thus remove sea lice (Treasurer, 1993).

### SUMMARY OF THE INVENTION

The present invention relates to the use of microbiological agents in the treatment or prevention of sea louse infestation.

In particular, the present invention provides the use of a microbiological agent other than a fungus for the manufacture of a biological control agent for treating or preventing sea louse infestation. Preferably the agent is a protozoan, bacterium or virus.

The invention further provides a protozoan, virus or bacterium isolatable from sea lice which is capable of infecting sea lice for use in treating or preventing a sea louse infestation.

In particular, the invention provides the organism referred to herein as BC-STIR01, deposited at the Culture Collection of Algae and Protozoa under Accession Number: CCAP 3047/1, or a mutant thereof which retains the ability to infect sea lice, especially sea lice of the species Lepeophtheirus salmonis, and the use of such organism for preventing or controlling a sea louse infestation. A biological control agent comprising this protozoan is also provided.

The invention also provides a cell line or culture system derived from sea louse homogenates and methods using such a cell line or culture system to screen for or to produce viral agents capable of exerting biological control of sea lice. The invention further provides the use of coelomic fluid from crustaceans as a supplement for such a cell line or culture system and a bioreactor system using cells cultured from sea lice used for the production of viruses capable of exerting biological control of sea lice.

### BRIEF DESCRIPTION OF THE DRAWINGS

FIG. 1: Normal adult female sea louse with intact egg strings

FIG. 2: Adult female L. salmonis heavily infected with BC-STIR-01. The whole body is opaque with parasite xenomas. Note aborted egg string (arrowed).

FIG. 3: Adult female L. salmonis less heavily infected with BC-STIR-01. Xenomas are concentrated around the lateral margins of the cephalothorax. Note aborted single egg string (arrowed).

FIG. 4: Cephalothorax of an adult female L. salmonis infected with BC-STIR-01. Note marked, dense inclusions in the lateral margins (lm) and frontal gland (fg) areas.

FIG. 5: Transmission electron microscopy (TEM) at magnification ×13,000 showing two mature spores (sp). Developing stages are present with clearly visible anchoring disc (ad) of the developing polar filament (pf).

FIG. 6: TEM ×22,000 showing developing sporont. Clearly visible are transverse sections of the coiled polar filament (pf) round the posterior vacuole (pv). Note 5 turns of the coiled filament.

FIG. 7: TEM ×5,900 showing sectioned xenoma with numerous mature spores and developing stages.

FIG. 8: Transverse histological section through abdomen of an adult female L. salmonis ×200 showing typical grossly enlarged cells (xenomas, x) between gut epithelium and cuticle. Xenoma contains numerous darkly staining spores and fragments of host material (hc), smaller developing xenomas (dx) are also present.

FIG. 9: Transverse histological section ×40 showing distribution of xenomas (x) throughout the abdomen in relation to the centrally positioned gut (g). Xenomas are in close contact with the haemolymph(h).

FIG. 10: Phylogenetic analysis of BC-STIR-01.

FIG. 11: Electron micrograph of virus particles detected in sea lice taken from the fish farm designated as “site A”. Examples of three viruses with different morphologies are arrowed in A and two in B.

FIG. 12: Effects of inoculating extract A into the mouthparts of sea lice in culture. Data are pooled from three series of experiments, showing all time points present for all three series. Data indicates survival as a % of the saline-inoculated group.

FIG. 13: A: Insect granulosis virus. Taken from Smith K. M. (1967) Insect Virology. Academic Press, New York, FIG. 36, page 116. B, C: Multipartite rod bundles seen in the gut of L. salmonis.

FIG. 14: A: Baculo A virus from Callinectes sapides, nucleus of hepatopancreatic epithelium. Taken from Johnson, P. T. & Lightner, D. V. (1988) Rod-shaped viruses of crustaceans: gut-infecting species, FIG. 5. B: Structures observed in the gut of L. salmonis. Both scalebars adjusted to 270 nm.

FIG. 15 A: Baculoviral midgland necrosis virus of penaeid shrimp. From Sinderman, C. J. & Lightner, D. V. (1988) Disease Diagnosis and Control in North American Marine Aquaculture. Elsevier, N.Y., FIG. 16, page 29. B: Structure observed beneath the cuticle in L. salmonis. Both scalebars are 250 nm.

FIG. 16: Virus observed in challenged L. salmonis. Scalebar in A is 200 nm, scalebar in B is 100 nm.

FIG. 17: Percentage of larvae with fluorescent gut after 3 hours exposure to fluorescent dextran at varying salinity.

FIG. 18: Fluid uptake by larvae over time in seawater at 6.4% NaCl. Measured as the proportion of larvae that take up FITC dextran (3 mg/ml) when exposed in batches of 300-500 larvae at 6.4% NaCl in 400 μl volumes for one hour.

### DETAILED DESCRIPTION OF THE INVENTION

The present invention is based on the identification and development of naturally-occurring infections of sea lice as microbiological agents and the formulation of such micobiological agents as biological control agents which may be used to control sea louse infestations in the farming of salmon and other fish. Suitable microbiological agents may be derived from infected sea lice or from marine environments, preferably those proximal to fish farms with known sea louse infestations.

Screening Methods

The present invention provides methods for the identification, characterisation, evaluation and development of novel microbiological agents derived from natural pathogens of sea lice and related crustacean species. Also provided are methods for the generation of cell cultures from sea lice for use in assays and/or the production of viral agents.

Microbiological agents with the potential to control sea louse infestations of farmed fish may be identified by a process of bioprospecting. This involves the identification of such agents by introduction of material from sources rich in sea lice or related crustaceans to captive sea lice and/or derived cell cultures.

Suitable material may be derived from a sample comprising sea lice or from a sample of seawater collected from an area of sea louse infestation. A suitable sample may be obtained from a fish farm or other source.

Samples are screened for suitable microbiological agents. A suitable microbiological agent may take the form of any microbiological agent which is capable of infecting sea lice. For example, a suitable agent may be a virus, protozoan or bacterium capable of infecting sea lice. Predators of sea lice such as carnivorous fish or multicellular ectoparasites such as Udonella caligorum are excluded from the present invention.

The elements of this bioprospecting process may differ depending upon the type of microbiological agent. Louse killing may be investigated under a range of conditions, and optimised by selective breeding where required. These studies may use conditions replicating those areas where the biological agent is intended to be used, in particular salmon containment facilities in marine environments.

Delivery systems and the stability of the microbiological agent may be evaluated and a stable form of the agent prepared for administration as described below.

Specificity of an agent may be evaluated using a range of crustaceans and other marine species, with direct evaluation of pathological effects and lethality. Examples of organisms for use in such studies include the brine shrimp, crab and lobster, where it is desired that the agent not cause deleterious effects.

Microbiological agents identified by such screening methods may be formulated as biological control agents which may be used to treat or prevent a sea louse infestation according to the present invention.

Isolation of Viral Agents

Sea lice may be collected from salmon farms and other sources. Other crustacea may also be collected from appropriate marine environments. Viral agents may be purified and extracted from the samples by any suitable method known in the art. For example, to release the viral particles, the sea lice or other crustaceans may be homogenised. In a preferred aspect, approximately 40 g of sea lice (approximately 1200-1500 lice) are homogenised in 150 ml of Hanks Balanced Salt Solution (HBSS). Homogenates may be clarified by centrifugation at, for example, 15,000×g for 20 min, then homogenates may be pelleted, for example by centrifugation at 130,000×g for 3 hours. Pelleted homogenates containing any possible virus particles may then be further purified. In a preferred aspect, purification is by centrifugation on a linear sucrose gradient (e.g. 15-30% sucrose) at 135,000×g for 2.5 hours.

Gradients are examined for the presence of virus containing bands, then harvested in suitable (e.g. 0.5 ml) fractions. The optical density of fractions is determined by spectrophotometry at 254 nm to enable identification of viruses present at levels below the limit of visual detection. Each fraction may also be examined by electron microscopy using phosphotungstate staining on standard grids for the presence of virus particles. Nucleic acid may be isolated from viruses by standard procedures, then further characterised, for example by digestion with DNase, RNase, and/or mung bean nuclease. This experimental procedure has successfully been used to isolate viruses from other crustaceans (Bruce et al 1991).

Alternatively, viruses may be isolated from sea water samples collected in or around fish farms, in particular those with known sea louse infestations. Viruses are the most common biological agents in seawater, typically numbering 10¹⁰ per litre (Fuhrman 1999). Viruses may be concentrated from seawater surrounding salmon farms with confirmed sea lice infection by adsorption and elution from positively charged microporous filters or by membrane filtration. These techniques are highly efficient in the recovery and concentration of virus particles from large volumes of water (Yano et al 1990, Pinto et al 1993, Wommack et al 1995).

Concentrated virus preparations obtained by any of these methods may added to cultures containing the motile stages of juvenile sea lice (nauplii and copepodids), which are examined for morbidity/mortality over a period of 14 days. Standard procedures as noted above are used to isolate viruses from lice exhibiting signs of disease.

In order to assess the pathogenicity of any viruses isolated, the virus may be replicated in order to challenge lice subpopulations.

Preferably, the virus is titrated in cell culture to determine infectivity for sea louse cells.

Prior to the establishment of cell cultures, lice may be challenged with virus particles isolated by the method outlined above. The resultant pathology is examined and any viral agents that reduce sea louse numbers may be characterised using morphological and molecular criteria.

In one embodiment, lice may be challenged with viral or other infectious agents, for example with a sea louse extract or viral suspension under hypertonic conditions. In such a system, larval stages of sea lice which do not normally take external material into their gut, since they are living off stored resources, are induced to do so by incubation for a limited period under hypertonic conditions. For example, larvae may be exposed to an infectious agent or control at 6.4% NaCl for one hour or more. In a preferred aspect, larvae are exposed 4 to 5 days after molting into the copepodid stage. After exposure, the copepodids may be released into fresh aerated seawater and examined subsequently, for example daily, for survival.

Publications on viruses of other Crustacea indicate that viral pathology may be expected within 48 hours, as seen herein with sea louse experiments. In routine diagnostic bioassays of juvenile shrimp injected with extracts from animals infected with Taura syndrome virus, death can be expected at 24-48 h (whereas protein shock kills in minutes) (Lightner, 1996) and BMV kills zoea II larvae of Penaeus japonicus within 2 days of exposure (Momoyama & Sano, 1989).

Isolation of Bacterial and Protozoal Agents

Samples of sea lice, for example collected from salmon farms or from seawater collected around salmon farms with known sea louse infestations, may be analysed for the presence of bacterial or protozoal agents. Bacteria or protozoa may be concentrated by centrifugation and/or filtration techniques. No selection for specific types of microorganism is used since it is important that no potential agents be missed.

Extracts of material from the above sources are introduced into colonies of juvenile sea lice which are then monitored for morbidity and/or mortality. For example, copepodids may be challenged with such extracts under hypertonic conditions to stimulate uptake of any infectious material into the gut as described above in relation to viruses. Extracts containing bacterial or protozoal agents may therefore be identified.

Material prepared from sea louse cultures in previous assays may be re-inoculated into fresh cultures. Where lice are killed by the re-infection, extracts are prepared and examined by high power light microscopy and, where required, by electron microscopy for the presence of identifiable bacteria or protozoa. Further purification of extracts by centrifugation will yield semi-purified extracts which can be reassessed, and from which stocks of the agent may be prepared on suitable gel media or in liquid cultures. Bacterial or protozoal agents difficult to grow under such conditions may be cultured in live sea lice.

Bacteria or protozoa isolated by these methods may be typed by standard taxonomical techniques including staining, morphological analysis and microsequencing.

Purified extracts showing control of sea lice may be subjected to a range of validation tests including repeat testing, environmental stability, and consistency of response.

Cell Lines and Culture Systems

The present invention further provides a cell line or culture system derived from sea lice. No culture system has been demonstrated previously for cells derived from sea lice. Such a culture system is highly desirable for the titration of viral agents and for the demonstration of their pathogenicity for sea louse cells. A cell culture system is also of use in reducing the costs of production for any viral biological control agent by allowing the use of bioreactor-based systems for such production. A cell line or culture system according to the present invention may be derived from sea lice, for example a sea lice homogenate, or from the unhatched eggs and/or egg strings of sea lice. A cell line or culture system may be derived from a single sea louse species, or from a number of species. Preferred species of sea louse for use in the construction of such a cell line or culture system are Lepeophtheirus salmonis and Caligus elongatus. A culture system according to the present invention may comprise further components standard in the art such as culture medium, growth factors.

A key element in the successful establishment of such cultures or cell lines is the provision of growth factors. For mammalian cells this is often provided by the inclusion of filtered calf serum, while for plant cells this can be provided the use of the autoclaved liquid endosperm of the coconut (“coconut milk”) (Harper, 2000). In the present invention, the preferred source of such growth factors is coelomic fluid from larger crustaceans, treated so as to remove microbiological contaminants, for example by filtration or autoclaving. Such crustaceans may include, but are not limited to crabs, lobsters or crayfish.

A cell line or culture system according to the present invention may be used in a method of screening for viral agents capable of exerting biological control of sea lice. Such a method may comprise adding a virus or a composition comprising a potential viral agent to the cell line or culture system and monitoring for evidence of biological control. For example, the cell line or culture system may be monitored for evidence of infection, pathogenicity or cell death. Confirmation of any such effects may suggest that the virus or composition may be suitable for use in the biological control of sea lice, for example as a control agent of the present invention. Such a screening method may lead to the identification of novel viruses suitable for use in the treatment or prevention of a sea louse infestation. Such viruses form a further aspect of the present invention.

A cell line or culture system according to the present invention may be used in a method of producing a viral agent capable of exerting biological control of sea lice. A viral agent capable of infecting such a cell line or culture system may be added and allowed to replicate. The viral particles so produced may then be harvested and may be used, for example, as a control agent of the present invention.

Agents for Administration

A suitable microbiological agent may be any agent identified or identifiable by the screening methods of the present invention. The present invention also encompasses microbiological agents derived from the original agent by selective breeding and/or mutagenesis by whatever means, for example the use of ultraviolet light or nitrous acid, for the purposes of increasing the effectiveness of the microbiological agent.

Suitable microbiological agents may be variously formulated as biological control agents for administration in, for example, fish farms, so as to reduce the population of sea lice. This may reduce the damage to fish resulting from such sea louse infestations and the damage to the environment resulting from the use of chemical approaches to sea louse control. A preferred microbiological agent will show specificity of infection. Such an agent will infect sea lice, preferably sea lice of more tan one species. Preferably such an agent will not infect fish, such as those fish farmed in areas proposed for treatment.

Protozoal Agents

The present invention provides protozoal agents for use in preventing or controlling sea louse infestation.

Any protozoal agent capable of infecting sea lice may be suitable. Preferably a protozoal agent will cause pathology and/or death in infected sea lice.

A suitable protozoal agent may be, for example, a protozoan of the phylum Microsporidia. This phylum is a large group of single celled organisms that live as parasites inside cells. Microsporidia infect cells by producing spores. On germination, the polar filament of such spores uncoils and penetrates the host cell. The microsporidian enters the cell through this filament and establishes infection. The microsporidian may then divide and multiply within the host cell before releasing a new generation of spores. A suitable agent for use in a method of the invention may therefore contain cells infected with microsporidia, or microsporidian spores.

In a preferred aspect, the agent is the organism referred to herein as BC-STIR-01 which was deposited by Dr D. H. Harper, Biocontrol Limited under the Budapest Treaty on the International Recognition of the Deposit of Microorganisms for the Purposes of Patent Protection at the Culture Collection of Algae and Protozoa (CEH Windermere, The Ferry House, Far Sawrey, Ambleside, Cumbria, LA22 0LP, United Kingdom) on Aug. 21, 2001 under accession number CCAP 3047/1. This organism was obtained using a screening method of the invention (see Examples 2 to 5). A suitable agent may therefore comprise cells infected with BC-STIR-01 or spores of BC-STIR-01.

Suitable variants of BC-STIR-01 may also be used in the methods of the invention. A suitable variant will include any mutant of BC-STIR-01 which retains the ability to infect sea lice. In particular, a suitable mutant may retain the ability to infect sea lice of the genus Lepeophtheirus salmonis.

A suitable variant of BC-STIR-01 will also include any other species within the same genus which retains the ability to infect sea lice, particularly Lepeophtheirus salmonis. Preferably, a variant of BC-STIR-01 will be a protozoan of the same species as BC-STIR-01 which retains the ability to infect sea lice, or shows an improved ability to infect sea lice, particularly Lepeophtheirus salmonis.

SEQ ID NO: 1 comprises the region 530 f to 580 r of the rDNA gene sequence of BC-STIR-01. This includes the ITS region. This sequence was used for phylogenetic analysis. This analysis suggests that this organism is a new microsporidian species and possibly a new genus. This organism does not appear to group phylogenetically with other crustacean-infecting microsporidian parasites.

A suitable microsporidian may comprise the DNA sequence given in SEQ ID NO: 1. In particular, such a microsporidian may comprise the same ITS region as the organism BC-STIR-01.

A suitable microsporidian may alternatively comprise a variant of such a sequence. The sequence of SEQ ID NO: 1 may be modified by nucleotide substitutions, for example from 1, 2 or 3 to 10, 25, 50 or 100 substitutions. The polynucleotide of SEQ ID NO: 1 may alternatively or additionally be modified by one or more insertions and/or deletions and/or by an extension at either or both ends. A variant of SEQ ID NO: 1 will generally have at least 60%, at least 70%, at least 80%, at least 90%, at least 95%, at least 98% or at least 99% sequence identity to the coding sequence of SEQ ID NO: 1 over a region of at least 20, preferably at least 30, for instance at least 40, at least 60, more preferably at least 100 contiguous nucleotides or most preferably over the full length of SEQ ID NO: 1.

Viral Agents

The present invention provides viral agents for use in preventing or controlling sea louse infestation. Any viral agent capable of infecting sea lice may be suitable. Preferably a viral agent will cause pathology and/or death in infected sea lice.

A suitable viral agent may be, for example, a baculovirus. The environmental stability and target specificity of baculoviruses makes them suitable for use in biological control.

A suitable agent for use in a method of the invention may therefore include a virus such as a baculovirus, or cells infected with a virus, such as a baculovirus.

Formulations

The present invention provides a biological control agent suitable for use in treating or preventing sea louse infestations. Microbiological agents identified according to the screening methods outlined above may be formulated with standard pharmaceutically acceptable carriers and/or excipients as is routine in the pharmaceutical art. For example, a suitable substance may be dissolved in saline or water. The precise formulation will depend on the particular microbiological agent to be administered, and may further comprise photoprotectant agents, stabilisers, emulsifiers, binders, buffers, anti-dessicants, dispersants or other active ingredients, in addition to any suitable inert carrier. The components of a biological control agent may vary depending on the particular type or species of sea louse being infected, for example different formulations may be effective against Lepeophtheirus salmonis and Caligus elongatus.

A suitable microbiological agent may comprise an organism as described above, or an agent derived from such an organism. For example, a biological control agent may comprise a microorganism such as a virus, bacterium or protozoan capable of infecting sea lice. A biological control agent may comprise a microbiological agent derived from such a microorganism, which agent is capable of treating or preventing sea louse infestation. For example, as described above, if the organism is a Microsporidian, the microbiological agent may be a spore. If the microbiological agent is a virus, the biological control agent may comprise cells infected by the virus.

A biological control agent according to the present invention may contain one or more microbiological agents. For example, a biological control agent may comprise different microbiological agents which are effective against different types or species of sea lice, in particular against Lepeophtheirus salmonis or Caligus elongatus.

The biological control agent may take the form of a stabilised formulation of the microbiological agent, for example as a dry powder, liquid, gel, paste or solid for immediate or prolonged release. Preferably administration is as a gel or solid producing slow release of the agent over a period of time, in order to maintain effective levels of the microbiological agent in the local environment.

A stabilised form of a microbiological agent may be a microencapsulated form using starch, styrene maleic acid anhydride half ester or another method.

Treatment

The present invention provides a method for treating or preventing sea louse infestations by applying a biological control agent of the invention at or proximal to the site of such infestations, or at or proximal to a site of potential infestation such as a fish farm. A site proximal to a site of infestation or potential infestation may be a site within a fish farm, such as a site within 1000 metres, within 500 metres or within 250 metres of the site of infestation or potential infestation. Preferably the agent is applied at the site of infestation. The agent may be applied at one or more individual sites or across a broad area, for example by spreading across the surface of the water. The site and range of application may be determined based on the particular location of the infestation or potential infestation and may take account of factors such as the area of the farm and the extent of the infestation.

A single microbiological agent may be applied in a biological control agent, or more than one microbiological agent may be applied in one or more biological control agents. The site and range of application of multiple agents may be determined based on, for example, the relative effectiveness of each agent and the localisation of the sea louse types or species being targetted.

The microbiological agent or biological control agent should be used in a dosage suitable to infect a population of sea lice. The dose used may be determined according to various parameters, especially according to the microbiological agent used; the species and distribution of the sea lice to be treated; and the potential effects of the agent on any other organisms such as fish, crustacea etc likely to be exposed to the agent. Dosage may be calculated to produce equivalent or greater reductions in sea louse numbers that are available by chemical methods, and/or to produce a significant reduction in sea louse numbers with minimal environmental risk. For example, dosage of the present invention may very between one and one billion infectious units per litre of treated water. More preferably, between ten thousand and one million infectious units are used, as evaluated for the individial biological control agent in captive sea louse populations.

### EXAMPLES

### Example 1

Cell Cultures Derived from Sea Lice

Homogenates of sea lice are prepared by mechanical disruption of sea lice or unhatched eggs using a pellet homogeniser. Prior to disruption, the surfaces of the material to be prepared are sterilised by exposure to germicidal ultraviolet irradiation and may be washed with medium containing double the normal level of antibiotics. Disrupted material is transferred to appropriate medium (for example L-15 medium, 0.4M NaCl, 10% FBS, 100 μg streptomycin, 100 U penicillin per ml, as described in Walton & Smith 1999). This establishes primary cultures.

Once primary cultures are well established (confluency is not necessarily achieved), cells are resuspended by scraping or treatment with proteolytic enzymes, suspended in fresh medium and reseeded into fresh plates. Sequential passaging of these cultures with establishment (and depositing where required) of seed stock results in the establishment of a recognised cell line.

Homogenates of sea lice are suspended in sterile culture media of or derived from the types used for mammalian, insect, crustacean and other invertebrate cell lines. Such media are prepared and supplemented in the manner used for the establishment of primary cell cultures from other species. A key element in the successful establishment of such cultures is the provision of growth factors. For mammalian cells this is often provided by the inclusion of filtered calf serum, while for plant cells this can be provided the use of the autoclaved liquid endosperm of the coconut (“coconut milk”) (Harper, 2000). In the present invention, the preferred source of such growth factors is coelomic fluid from larger crustaceans, treated so as to remove microbiological contaminants, for example by filtration or autoclaving. Such crustaceans may include, but are not limited to crabs, lobsters or crayfish.

Cultures are then transferred to growth vessels and incubated at appropriate temperatures, preferably in the range of 4° C. to 30° C. Growth is monitored by light microscopy. Cultures in which cell growth is established are examined and subcultured under appropriate conditions.

### Example 2

Protozoal Agents

Samples of sea lice collected from salmon farms as well as from seawater collected around salmon farms with known sea louse infestations are analysed for the presence of protozoal agents. Protozoa are concentrated by centrifugation and/or filtration techniques. No selection for specific types of protozoa is used since it is important that no potential agents be missed.

Extracts of material from the above sources are introduced into colonies of juvenile sea lice which are then monitored for pathology and/or killing of sea lice.

Material prepared from sea louse cultures in previous assays is re-inoculated into fresh cultures. Where lice are killed by the re-infection, extracts are prepared and examined by high power light microscopy and, where required, by electron microscopy for the presence of identifiable protozoa. Further purification of extracts by centrifugation yields semi-purified extracts which can be reassessed, and from which stocks of the agent can be prepared on suitable gel media and in liquid cultures. Protozoal or fungal agents difficult to grow under such conditions are cultured in live sea lice.

Protozoa isolated by these methods are typed by standard taxonomical techniques including staining, morphological analysis and microsequencing.

Purified extracts showing control of sea lice may be subjected to a range of validation tests including repeat testing, environmental stability, and consistency of response.

Louse killing by the agent is investigated under a range of conditions, and optimised by selective breeding where required. These studies may use conditions replicating areas where the biological agent is intended to be used, in particular salmon containment facilities in marine environments.

Delivery systems and the stability of the agent are evaluated and a stable form of the agent prepared for administration as noted above.

Specificity of a protozoal biocontrol agent is evaluated using a range of crustaceans and other marine species, with direct evaluation of pathological effects and lethality. Examples of organisms for use in such studies include the brine shrimp, crab and lobster, where it is desired that the agent not cause deleterious effects.

### Example 3

Identification of a Protozoan Agent in Sea Lice

Infections in the salmon louse Lepeophtheirus salmonis were confirmed at three sites on the West Coast of Scotland. At one site, (site A), infections were far more prevalent than at the other two sites.

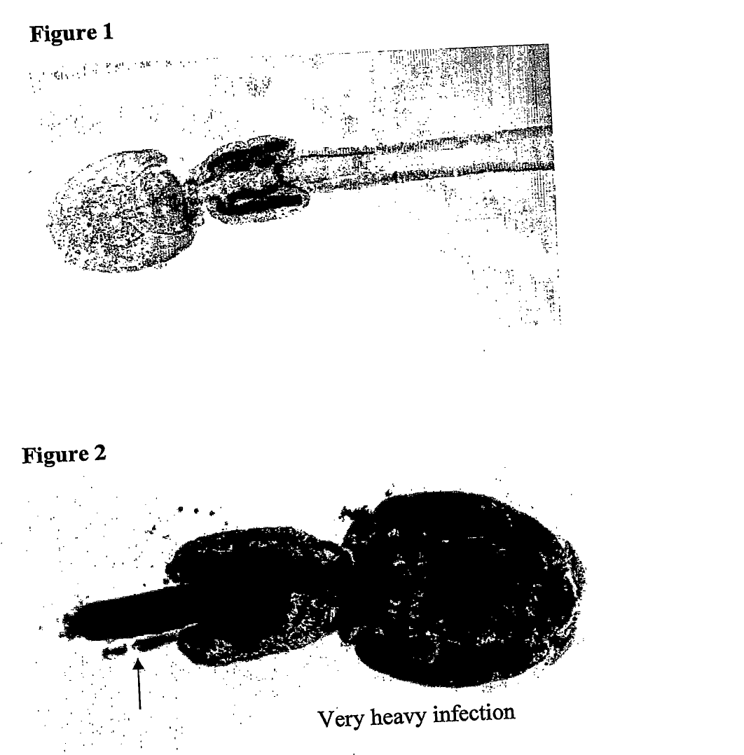

Heavily infected lice are easily detectable grossly by the appearance of dense inclusions visible through the integument (FIGS. 1, 2, 3 and 4). Heavily infected adult females manifesting this appearance constituted 3-10% of samples examined from site A between November 2000 and February 2001. This number decreased subsequent to February 2001, and on visits to site A on Mar. 29^{th} 2001 and Jun. 8^{th} 2001 none were found. However, when lice collected from site B on Apr. 17^{th} 2001 were examined, up to 1% of the lice were still showing the gross signs of infection. There may be a seasonal trend emerging, or intra/inter-site variability/sampling differences.

The actual prevalence level in these three sites has not been determined and is likely to be considerably higher than this as the parasite is intra-cellular and not readily detectable grossly at the pre-sporogonic stages.

Morphology

Fresh squashes of infected lice showed large numbers of immature and/or mature spores. Although microsporidian spores are characteristic in their morphology, this species was notable for the extreme small size of the spore and because the posterior vacuole was not readily visible under phase contrast. There is little difference in spore morphology under light microscopy between genera and species of microsporidia and species cannot be discriminated on spore form alone. Current taxonomy is based on ultrastructural features viewed in the electron microscope. There is considerable doubt surrounding the current systems of taxonomy and several molecular studies have been attempted to examine taxonomic relationships (Franzen & Muller, 1999; Nilsen, 2000 & Bell, 2001).

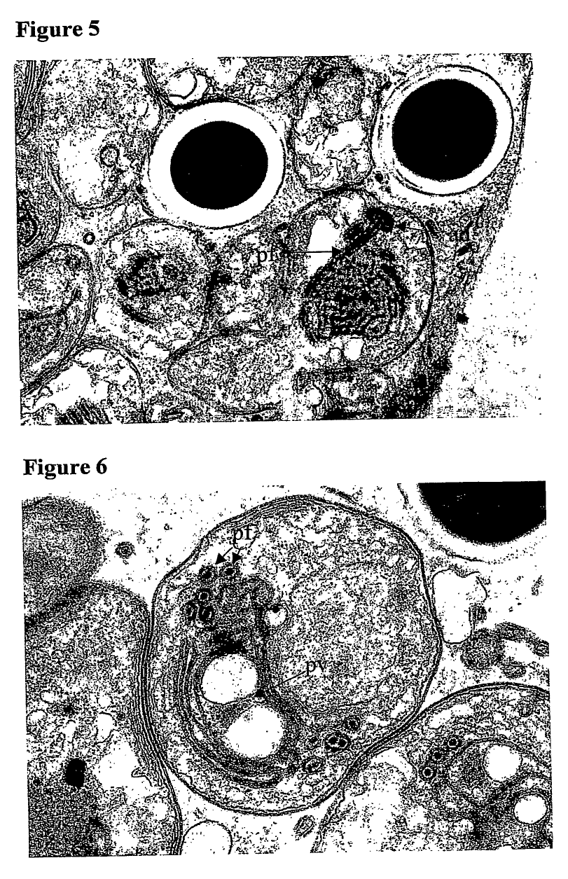

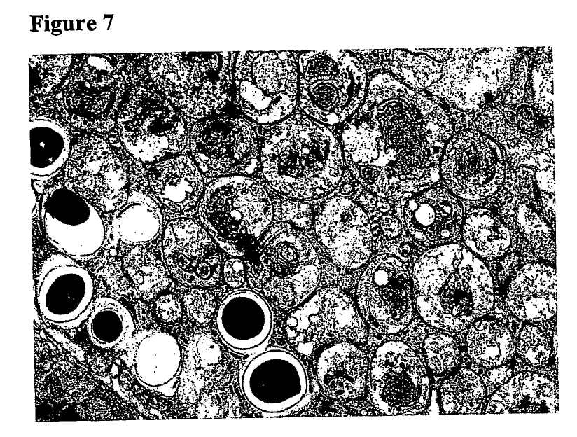

Electron microscopy of the microsporidian from L. salmonis has shown mature spores to be almost spherical and about 1-2 μm in size, with a coiled polar filament of 5-7 turns (FIGS. 5, 6 and 7). Early stage sporonts and meronts have been found.

The provisional name for the new microsporidian hyperparasite is:

Microsporidium lepeophtheiri

The collective group Microsporidium (Balbiani 1884), is a depository for ‘identifiable species of which the generic positions are for the time being uncertain’ (Sprague 1977). The species name is taken from the initial and only host identified so far, the salmon louse Lepeophtheirus salmonis.

### Example 4

Pathology of Protozoan Infection

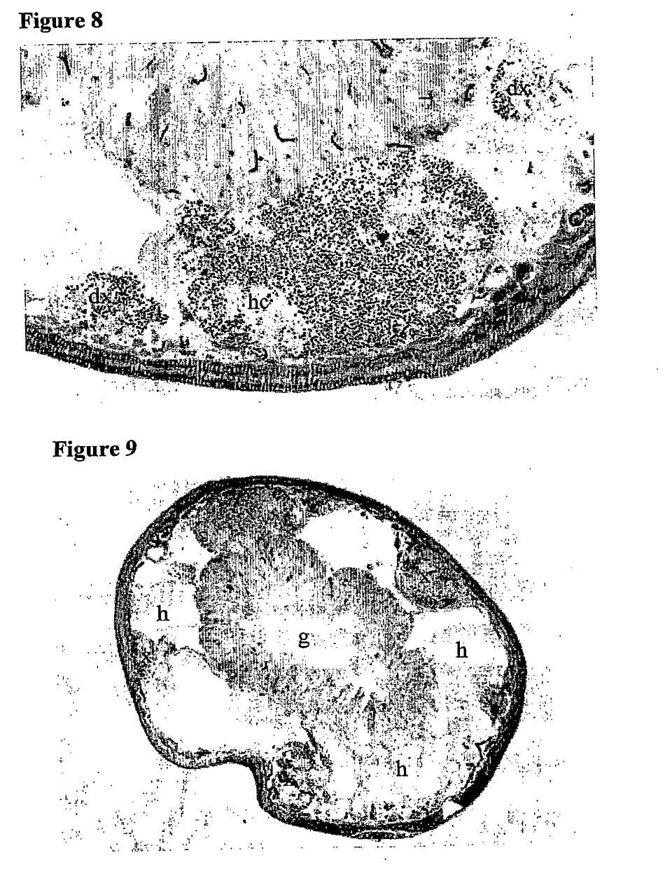

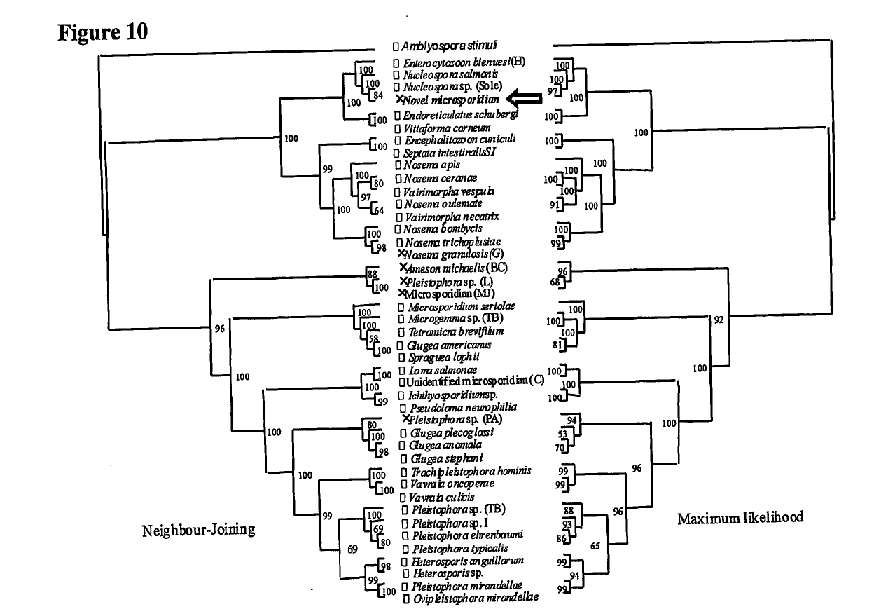

Wax sections of heavily infected adult females have been prepared and examined under light microscopy (FIGS. 8 and 9). These sections have shown:

Large xenomas (grossly hypertrophied cells) containing massive numbers of spores are ubiquitous throughout the body, including the appendages.

Xenomas contain SPV's (sporophorous vesicles) with numerous developing spores.

Infection appears to be in ‘dendritic/mesenchyme’ type cells, in the sub-integumentary tissue. The host cell type has yet to be confirmed.

Infections have not been detected in striated muscle cells and possibly not in smooth muscle.

Infection has not been detected so far in ovaries and egg strings.

Mature xenomas appear to breakdown internally.

Free spores are present in the gut lumen.

Free spores are present in the haemolymph.

Free spores are associated with external membranes of eggs.

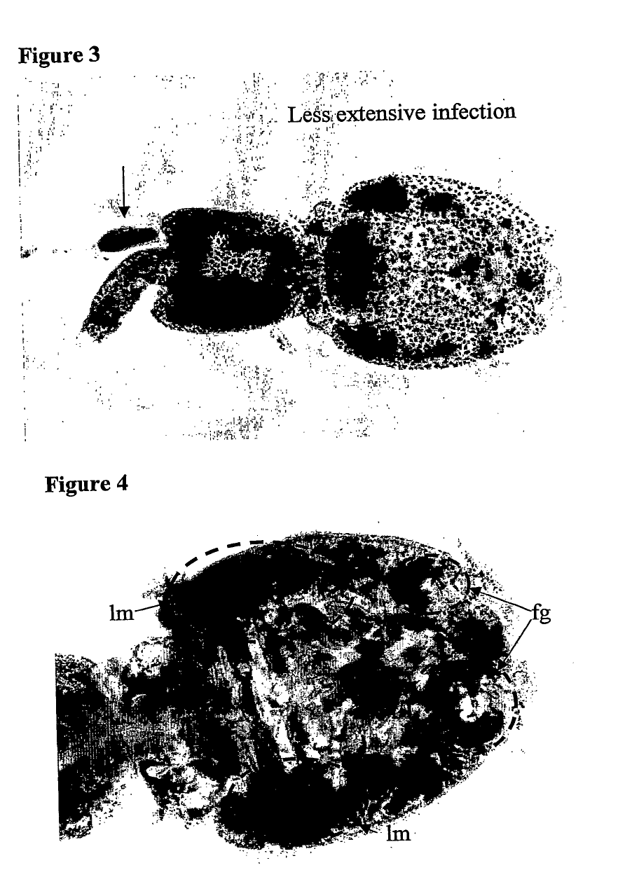

Histology shows a major impact on lice tissues but ovogenesis and egg extrusion can be seen in sections of heavily infected lice. Malformed egg sacs have been observed on infected lice (FIGS. 2 and 3). This presence of broken egg strings on heavily infected female lice may indicate a mechanism of pathology based on disruption of reproduction. Vertical transmission may take place.

It can be noted that, although continuously infected with L. salmonis, the manager of site A has not found it necessary to treat for lice numbers so far this year. This suggests that a control agent is acting on the sea lice present at this site, a role for which the novel microsporidian would be a strong candidate.

### Example 5

Identity of the Protozoan in Sea Lice

A sample of the microsporidian identified in Example 3 was deposited on Aug. 21, 2001 under accession number CCAP 3047/1 at the Culture Collection of Algae and Protozoaas indicated above.

The complete rDNA gene sequence for the ITS region of the microsporidian identified in Example 3 has been determined. The methodology was as follows:

Purified spores were pelleted (approx. 20 μl in volume), washed in either high molecular weight buffer (HMW: 10 mM Tris-HCl, pH 8.0; 150 mM NaCl; 10 mM EDTA) or high concentration urea buffer (TNES-Urea: 10 mM Tris-HCl, pH 7.5; 125 mM NaCl; 10 mM EDTA; 0.5% SDS; 4 M urea), resuspended in 0.5 ml of the same medium and vortexed (in a manner to maximise shearing directions) for 1 min with 0.4 g of 0.5 mm silica beads to facilitate the mechanical disruption of mature spore walls. After centrifugation at 1,000 g for 3 min, the supernatant was removed, its volume adjusted to 500 μl, proteinase K added to a concentration of 100 μg/ml, and digestion allowed to occur overnight in a 37° C. tilting water bath. DNA was subsequently extracted with Tris-saturated phenol and phenol: chloroform: isoamylalcohol (25:24:1), treated with RNase A, further extracted with phenol: chloroform: isoamylalcohol (25:24:1) and diethyl ether, and then precipitated at −80° C. with 2.5×volume of 95% cold ethanol and 0.1×volume 4M sodium acetate, and finally re-suspended in MilliQ water. DNA concentrations and purities were checked on a Pharmacia GeneQuant RNA/DNA calculator.

DNA Amplification and Sequencing:

Targeted DNA (c. 1400 bp) was amplified using the PCR primers described by Vossbrinck et al. (1993): forward primer 530 f (5′-GTGCCATCCAGCCGCGG-3′), reverse primer 580r (5′-GGTCCGTGTTTCAAGACGG-3′). Each 25 μl PCR reaction contained ˜10 ng of genomic DNA, 25 pmol of each primer and utilised Ready-To-Go™ PCR Beads (Amersham Pharmacia Biotech) which comprise ˜1.5 units of Taq DNA polymerase, 10 mM Tris-HCl, (pH 9.0 at room temperature), 50 mM KCl, 1.5 mM MgCl₂, 200 μM of each dNTP and stabilisers including BSA. After an initial denaturation at 95° C. for 5 min, samples were subjected to 30 cycles of amplification (denaturation at 95° C. for 30 sec, primer annealing at 43° C. for 30 sec, and extension at 72° C. for 1 min), followed by a 10 min terminal extension at 72° C. All amplifications were performed on a Perkin-Elmer GeneAmp PCR System 2400 thermocycler. The PCR product obtained was visualised in an ethidium bromide-stained 1% agarose gel, the DNA band excised and purified using the Prep-A-Gene DNA purification kit (Bio-Rad Laboratories).

Sequences were determined directly from the PCR products. Cycle sequencing reactions using the BigDye Terminator™ Sequencing Kit (Perkin-Elmer Corporation) and incorporating the same primers as those used in the initial PCR's were performed according to the manufacturer's instructions. Sequencing products were run on an ABI Prism 377 automated sequencer (Perkin-Elmer Corporation). Sense and anti-sense strands were sequenced for all products (full 530 f-580 r region and internal amplicon) and four replicates (PCR products amplified from separate DNA extractions) performed for each gene region. The sequence determined is given in SEQ ID NO: 1.

CLUSTAL W (Thompson et al., 1994) was used for initial sequence alignments with default settings for gap and weighting values. Regions of ambiguous alignment were identified visually and removed prior to analyses. Alignment files were converted into distances by the Kimura 2 parameter and trees constructed using the Neighbour-joining (N-J) algorithm (Saitou and Nei, 1987) within the Phylogeny Inference Package (PHYLIP version 3.57; Felsenstein, J., 1993. PHYLIP: phylogeny inference package, version 3.5c. University of Washington, Seattle, Wash.). In addition, cladograms were produced from the alignment files using the Maximum-Likelihood (M-L) algorithm. Numerical values at branch points indicate the number of 1000 bootstrap replicates that support the observed tree. Amblyospora spp. that occupy a basal phylogenetic position within the Microspora were used as outgroups in the cladistic analyses.

The region of the ribosomal RNA gene amplified by the primers 530 f and 580R extends from within the small sub unit (a.k.a 16S, this is a sedimentary coefficient that denotes size) through the ITS (internal transcribed spacer) region and into the large sub unit (23S).

These primers are universal and will amplify DNA from most organisms, as the primer regions are highly conserved in most taxa The nomenclature for the primers arises from the distance within each sub unit the primers target on the universal standard DNA from the bacterium E. coli. ie: the primers target E. coli DNA 530 bases into the small sub unit and 580 bases into the large sub unit. In this case the whole sequence is about 1400 bases long, making the ITS region just under 300 bases in length. This will vary in different organisms due to insertions or deletions to that region. Most higher taxa have two ITS regions, making the whole sequence about 2500 bases long, but microsporidians only have one.

The region of the small sub unit is the most conserved, variation here would mean genus and family differences, the large sub unit is less conserved, but large differences here would indicate differing genera. The least conserved and hence most variable region is that of the ITS. Here differences could be attributed to a species level. However, the ultimate positioning of a new organism must consider other factors, such as the relative placements of other known similar parasites from the same phyla, taking into account general biology, host type, life cycles, morphology etc.

Usually organisms with 98% or more homology will be in the same genus, some genera may only have 1.2% differences across all of its members, however in other cases there may be more than 1.2% differences between two species of the same genus. Data obtained from this analysis revealed that the organism is a new microsporidian species and possibly a new genus. Phylogenetic analyses have shown that it does not group with other crustacean-infecting microsporidian parasites (see FIG. 10). The closest relatives demonstrated by this analysis are Nucleospora species infecting salmon and sole (Khattra et al, 2000). This suggests that the new species may have transferred from the salmon host, and may actually replicate in both the salmon and the sea louse, transferring to the latter during ingestion of fish tissue. The complete 1400 base sequence from our microsporidian, has 89% homology with the closest available to date on the databases, this is with Nucleospora salmonis and Enterocytozoon bieneusi.

### Example 6

Viral Agents

Viral agents are isolated by a process of bioprospecting. The elements of this process are as follows:

Sea lice are collected from salmon farms and other sources. Other crustacea may also be collected from appropriate marine environments. Approximately 40 g of sea lice (approximately 1200-1500 lice) or other crustaceans are homogenised in 150 ml of Hanks Balanced Salt Solution (HBSS). Homogenates are clarified by centrifugation at 15,000×g for 20 min, then homogenates are pelleted by centrifugation at 130,000×g for 3 hours. Pelleted homogenates containing any possible virus particles are further purified by centrifugation on a linear 15-30% sucrose gradient at 135,000×g for 2.5 hours. Gradients are examined for the presence of virus containing bands, then harvested in 0.5 ml fractions. The optical density of fractions is determined by spectrophotometry at 254 nm to enable identification of viruses present at levels below the limit of visual detection. Additionally, each fraction is examined by electron microscopy using phosphotungstate staining on standard grids for the presence of virus particles. Nucleic acid is isolated from viruses by standard procedures, then further characterised by digestion with DNase, RNase, and mung bean nuclease. This experimental procedure has successfully been used to isolate viruses from other crustaceans (Bruce et al 1991).

Alternatively, viruses are isolated from seawater samples collected in or around fish farms, in particular those with known sea louse infestations. Viruses are the most common biological agents in seawater, typically numbering 10¹⁰ per litre (Fuhrman 1999). Viruses are concentrated from seawater surrounding salmon farms with confirmed sea lice infection by adsorption and elution from positively charged microporous filters or by membrane filtration. These techniques are highly efficient in the recovery and concentration of virus particles from large volumes of water (Yano et al 1990, Pinto et al 1993, Wommack et al 1995).

Concentrated virus preparations are then added to cultures containing the motile stages of juvenile sea lice (nauplii and copepodids), which are examined for morbidity/mortality over a period of 14 days. Standard procedures as noted above are used to isolate viruses from lice exhibiting signs of disease.

In order to assess the pathogenicity of any viruses isolated, the virus is replicated in order to challenge lice subpopulations.

Preferably, the virus is titrated in cell culture to determine infectivity for sea louse cells.

Prior to the establishment of cell cultures, lice are challenged with virus particles isolated by the method outlined above. Resultant pathology is examined and viral agents that reduce sea louse numbers are characterised using morphological and molecular criteria.

Louse killing by the agent is investigated under a range of conditions, and optimised by selective breeding where required. These studies may use conditions replicating areas where the biological agent is intended to be used, in particular salmon containment facilities in marine environments.

Delivery systems and the stability of the agent are evaluated and a stable form of the agent prepared for administration as noted above.

Specificity of a viral biocontrol agent is evaluated using a range of crustaceans and other marine species, with direct evaluation of pathological effects and lethality. Examples of organisms for use in such studies include the brine shrimp, crab and lobster, where it is desired that the agent not cause deleterious effects.

### Example 7

Identification of a Viral Agent in Sea Lice

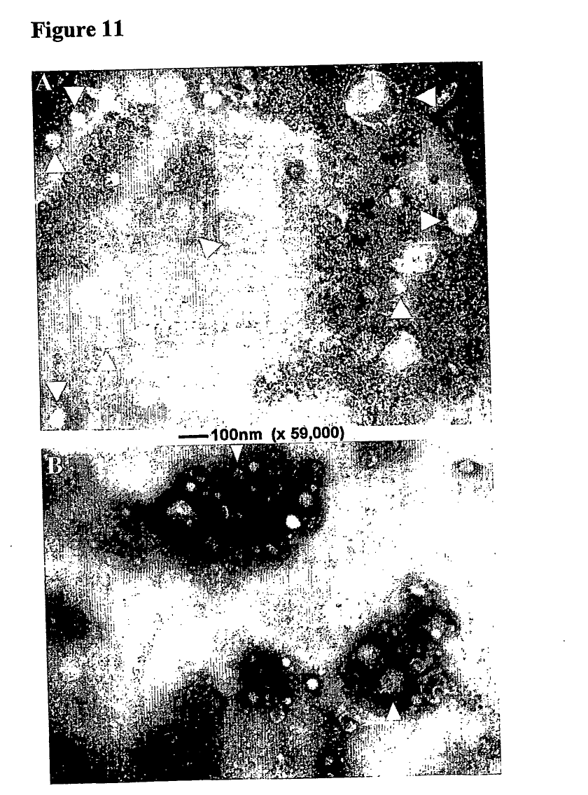

Samples of sea lice were obtained from a fish farm designated as “site A”. These samples were lysed as described in Example 6 above. The material prepared from these lysates was analysed by electron micrography and virus particles were detected (see FIG. 11).

While viruses are expected in any marine material, extracts of sea water from the same source show only 2% of the number of virus particles seen in these extracts. This demonstrates the presence of virus particles in sea lice.

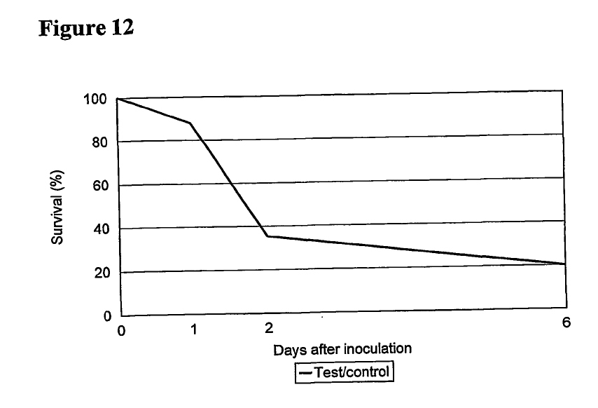

The Extract derived from Site A was inoculated into the mouthparts of sea lice in culture. FIG. 12 shows data pooled from three series of experiments, showing all time points present for all three series. Mortality was seen in the control (saline-inoculated) group since the procedure can cause damage to the mouthparts. However, the killing of lice treated with the extract was dramatically higher than in the control group.

### Example 8

Identification of a Baculovirus in Sea Lice

Baculoviruses show several distinctive forms within infected cells, and corresponding structures have now been observed within the gut cells of L. salmonis treated with louse material thought to contain candidate biological control agents. The location and appearance of these structures is a strong indication of the presence of novel baculoviruses.

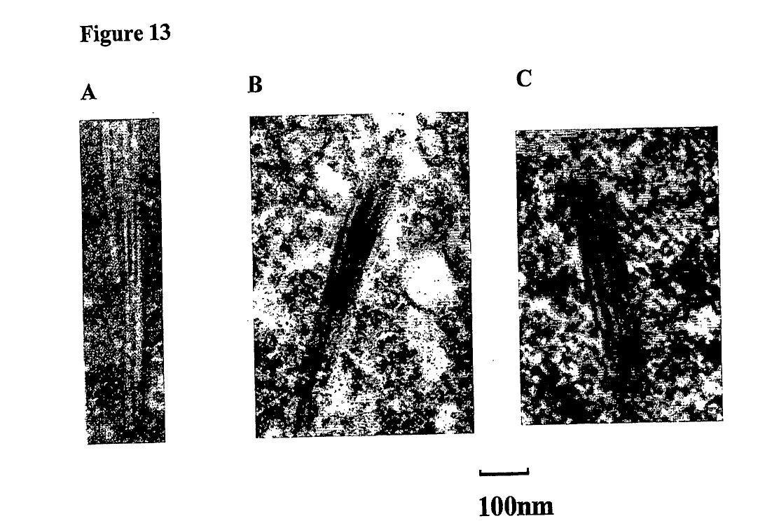

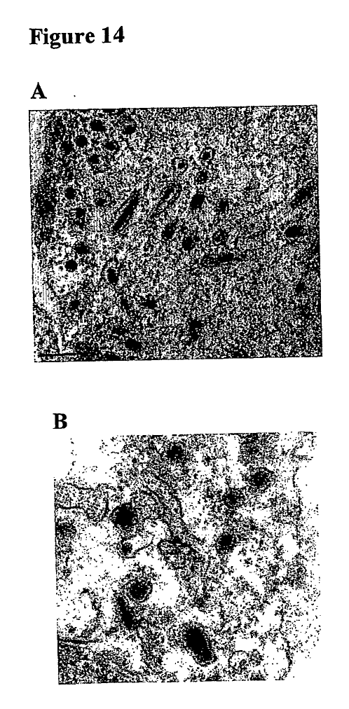

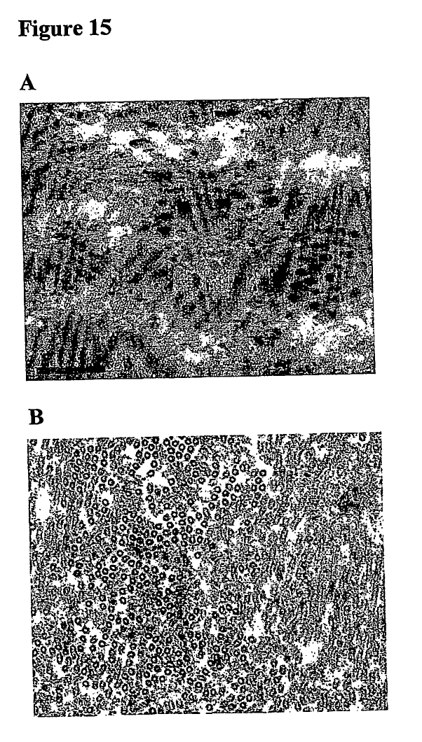

The baculoviral midgland necrosis virus of penaeid shrimp causes structures similar in appearance to those seen in insect granulosis virus (see FIG. 13A). Similar structures were observed in the gut of L. salmonis sea lice treated with this lysate (see FIGS. 13B and 13C). Killing of the L. salmonis was observed, in a similar time frame to the effects of baculoviral midgland necrosis virus in penaeid shrimp. Cytoplasmic structures within vacuoles were observed within the gut of the infected L. salmonis (see FIG. 14B). These showed similar appearance to Baculo A virus from Callinectes sapides (see FIG. 14A). Further structures were observed beneath the cuticle in infected L. salmonis (see FIG. 15B). Again, these were similar to structures observed in penaeid shrimp infected with baculoviral midgland necrosis virus (see FIG. 15A).

### Example 9

Establishment of a Viral Infection in Larval and Adult L. Salmonis

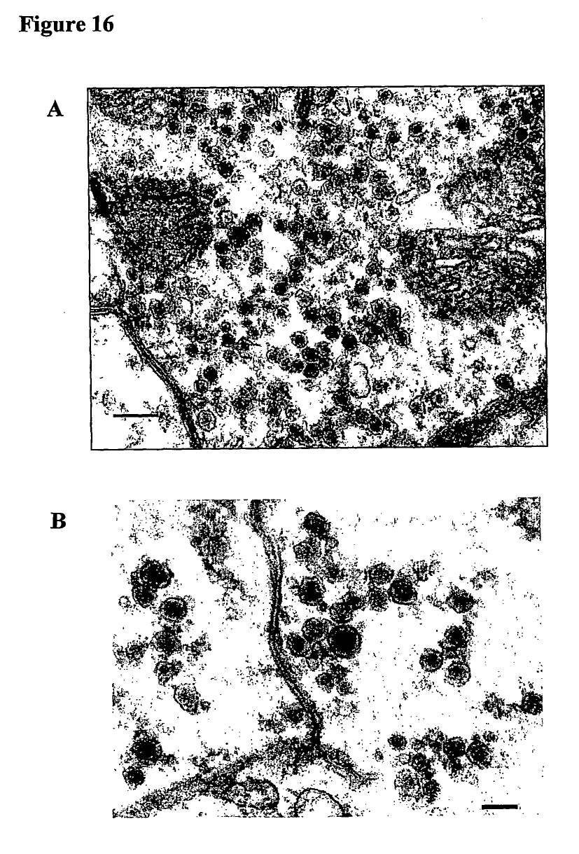

A virus with morphological similarity to C-type oncoviruses was detected in both larval and adult L. salmonis within 24 to 48 hours of the challenge with sea louse extracts (see FIG. 16).

The larval stages of crustaceans and other invertebrates are particularly vulnerable to viral infections and therefore present ideal targets for challenges. L. salmonis has three larval stages which are free-living but do not feed until the final stage (the copepodid) infects a host.

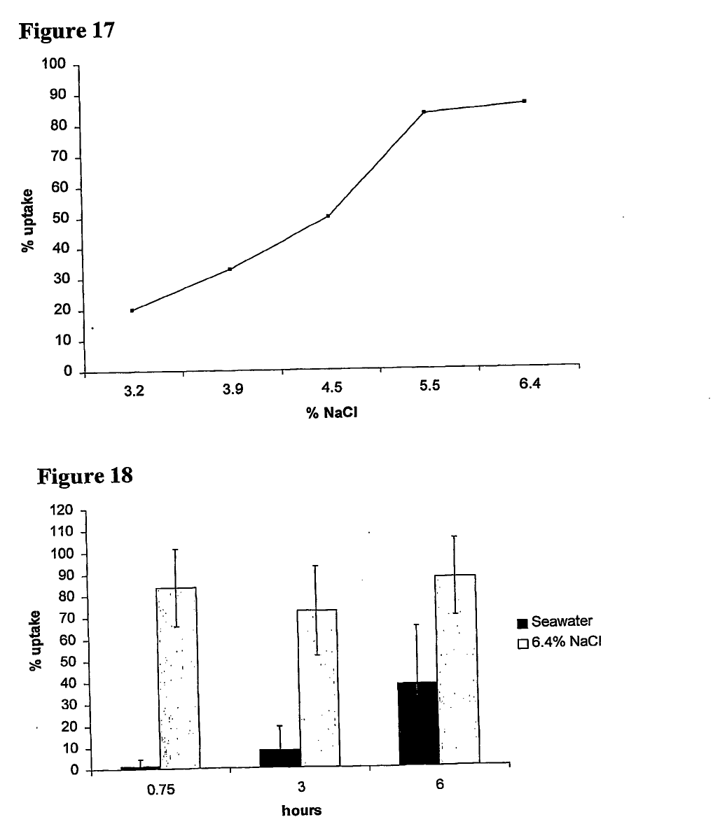

The copepodid stage has a gut and peristaltic movements are frequently apparent. To investigate the possibility of challenging larvae by exposure to viral suspensions, fluid uptake was measured in copepodids exposed to fluorescent dextran. Larvae were exposed for different times (3 hours to overnight) in a range of salinities at 4° C., washed repeatedly in fresh seawater and examined under an Olympus fluorescent microscope. As show in FIGS. 17 and 18 it is apparent that uptake rates increase with salinity, but there does not appear to be a strong effect with regard to exposure time. Uptake rates also appear to depend on age. The best time for exposure was determined to be at 4 to 5 days after molting into the copepodid stage.

Based on these observations, a protocol for exposing copepodids in infection cells was devised. Batches of 300 to 500 larvae were exposed to a viral suspension or control at 6.4% NaCl in 400 microlitre volumes for one hour. Fluid uptake in separate controls was measured as the proportion of larvae that took up FITC dextran (3 mg/ml) under the same conditions. After exposure, the copepodids were released into fresh aerated seawater (100 ml per batch) and examined daily for survival. This method may be scaled up in time. Initially, a 24 well tissue culture place is used for challenges. This protocol may be used to expose larvae to sea louse extract or control buffer under hypertonic conditions for a set period of time prior to release into fresh seawater aquaria. The larvae will survive for several days after the challenge.

Increased mortality was observed in challenged animals from 24 hours after exposure to sea louse extract and virus was observed in specimens derived from three successive challenge experiments. Localised infections by the same virus was observed in glandular, nerve and gut epithelial tissue of injected adults from 48 hours post challenge.

### Example 10

Bacterial Agents

Bacterial agents are isolated by a process of bioprospecting. The elements of this process are as follows:

Samples of sea lice collected from salmon farms as well as from seawater collected around salmon farms with known sea louse infestations are analysed for the presence of bacterial agents. Bacteria are concentrated by centrifugation and/or filtration techniques. No selection for specific types of bacteria is used since it is important that no potential agents be missed.

Extracts of material from the above sources are introduced into colonies of juvenile sea lice which are then monitored for pathology and/or killing of sea lice. Material prepared from sea louse cultures in previous assays is re-inoculated into fresh cultures. Where lice are killed by the re-infection, extracts are prepared and examined by high power light microscopy and, where required, by electron microscopy for the presence of identifiable bacteria. Further purification of extracts by centrifugation yields semi-purified extracts which can be reassessed, and from which stocks of the agent can be prepared on suitable gel media and in liquid cultures. Bacterial agents difficult to grow under such conditions are cultured in live sea lice.

Bacteria isolated by these methods are typed by standard taxonomical techniques including staining, morphological analysis and microsequencing.

Purified extracts showing control of sea lice may be subjected to a range of validation tests including repeat testing, environmental stability, and consistency of response.

Louse killing by the agent is investigated under a range of conditions, and optimised by selective breeding where required. These studies may use conditions replicating areas where the biological agent is intended to be used, in particular salmon containment facilities in marine environments.

Delivery systems and the stability of the agent are evaluated and a stable form of the agent prepared for administration as noted above.

Specificity of a bacterial biocontrol agent is evaluated using a range of crustaceans and other marine species, with direct evaluation of pathological effects and lethality. Examples of organisms for use in such studies include the brine shrimp, crab and lobster, where it is desired that the agent not cause deleterious effects.

References

Bell, A. S. Aoki, T. & Yokoyama, H. (2001). Phylogenetic relationships among microsporidia based on rDNA sequence data, with particular reference to fish-infecting Microsporidium Balbiani 1884 species. Journal of Eukaryotic Microbiology 48 (3) 258-265.

Bruce L D, Trumper B B, Lightner D V (1991). Methods for viral isolation and DNA extraction for a penaeid shrimp baculovirus. Journal of Virological Methods 34 245-254.

Costello M J (1993). Review of methods to control sea lice (Caligidae: Crustacea) infestations on salmon (Salmo salar) farms. In “Pathogens of wild and farmed fish: sea lice”, G A Boxshall and D. Defaye (eds.), pp. 220-252, Ellis Horwood, N.Y.

Franzen, C. and Muller, A. (1999). Molecular techniques for detection, species differentiation, and phylogenetic analysis of microsporidia. Clinical microbiology reviews 12 (2) 243-285.

Fuhrman J A (1999) Marine viruses and their biogeochemical and ecological effects. Nature 399 541-548.

Harper D R (2000). Viral culture methodologies. In “Encyclopaedia of Life Sciences”, Macmillan Reference Ltd., London.

Jackson D, Minchin D (1993). Lice infestation of farmed salmon in Ireland. In “Pathogens of wild and farmed fish: sea lice”, G A Boxshall and D. Defaye (eds.), pp. 189-201, Ellis Horwood, N.Y.

Khattra, J. S., Gresoviac, S. J., Kent, M. L., Myers, M. S., Hedrick, R. P. & Devlin, R. H. (2000). Molecular detection and phylogenetic placement of a microsporidian from English sole (Pleuronectes vetulus) affected by X-cell pseudotumors. Journal Of Parasitology 86: 867-871.

Lightner, D. V. (1996). A Handbook of Pathology & Diagnostic Procedures for Diseases of Penaeid Shrimp. World Aquaculture Society, Baton Rouge, La., USA.

Lom, J. and Dykova, I. (1992). Developments in aquaculture and fisheries science, vol 26: Protozoan parasites of fishes.

Momoyama, K. & Sano, T. (1989). J. Fish. Diseases 12, 585-589.

Nilsen, F. (2000). Small subunit ribosomal DNA phylogeny of microsporidia with particular reference to genera that infect fish. Journal of Parasitology 86: 12-133.

Pinto R M, Jofre J, Abad F X, Gonzales-Dankaart J F, Bosch A (1993) Concentration of fish viruses from large volumes of water. Journal of Virological Methods 43 31-40

Saitou, N. & Nei, M. (1987). The neighbour joining method: a new method for reconstructing phylogenetic trees. Molecular and Biological Evolution 4:406-425.

Sprague, V. (1977). Classification and phylogeny of the Microsporidia In: Bulla, L. A. Jr. and Cheng, T. C. (Eds), Comparative pathobiology, vol 2, systematics of the microsporidia. Plenum Press, New York, 510 pp.

Thompson, J. D., Higgins, D. G. & Gibson, T. J. (1994). CLUSTAL W: improving the sensitivity of progressive multiple sequence alignment through sequence weighting, position-specific gap penalties and weight matrix choice. Nucleic Acids Research 22: 4673-4680.

Treasurer J W (1993). Management of sea lice (Caligidae) with wrasse (Labridae) on Atlantic salmon (Salmo salar L.) farms. In “Pathogens of wild and farmed fish: sea lice”, G A Boxshall and D. Defaye (eds.), pp. 336-345, Ellis Horwood, N.Y.

Vossbrinck, C. R., Baker, M. D., Didier, E. S., Debrunner-Vossbrinck, B. A. & Shadduck, J. A. (1993). Ribosomal DNA sequences of Encephalitozoon hellem and Encephalitozoon cuniculi: species identification and phylogenetic construction. Journal of Eukaryotic Microbiology 40: 354-362.

Walton A, Smith V. J. (1999) Fish & Shellfish Immunology 9 181-191.

Wommack K W, Hill R T, Colwell R R (1995) A simple method for the concentration of viruses from natural waters. Journal of Microbiological Methods 22 57-67.

Yano K, Yoshida Y, Kaneko M (1990) Improvement of the zeta-plus filter method for the concentration of viruses from water. Water Science Technology 24 217-220.

1. Use of a microbiological agent other than a fungus for the manufacture of a biological control agent for treating or preventing sea louse infestations

2. Use according to claim 1 wherein said microbiological agent is, or is derived from, a protozoan, a bacterium or a virus.

3. Use according to claim 2 wherein said microbiological agent is cells or spores of a protozoan found in sea lice which is capable of infecting sea lice.

4. Use according to claims 2 or 3 wherein said protozoan is an organism of the phylum Microsporidia.

5. Use according to claim 4 wherein said organism is the protozoan deposited under Accession Number CCAP 3047/1 at the Culture Collection of Algae and Protozoa or a mutant thereof which retains the ability to infect sea lice, especially of the species Lepeophtheirus salmonis.

6. Use according to claims 4 or 5 wherein the genome of said organism includes a sequence according to SEQ ID NO: 1 or a sequence having at least 90% homology, preferably 95% homology, more preferably 98% homology to the sequence of SEQ ID NO: 1.

7. Use according to claim 2 wherein said microbiological agent is a virus found in sea lice which is capable of infecting sea lice.

8. Use according to claim 7 wherein said virus is a baculovirus or C-type oncovirus.

9. Use according to any of the preceding claims wherein said medicament is applied at or proximal to a site of sea louse infestation.

10. Use according to any one of the preceding claims wherein the louse so controlled is Lepeophtheirus salmonis or Caligus elongatus.

11. Use according to any one of the preceding claims wherein said medicament is used for control of sea louse infestation on a fish farm.

12. Use according to claim 1 wherein said agent is a mutated, adapted or selectively bred from of an agent described in any of the preceding claims which has been produced to counter the development of resistance by sea lice.

13. The organism deposited under Accession Number CCAP 3047/1 at the Culture Collection of Algae and Protozoa (CEH Windermere, The Ferry House, Far Sawrey, Ambleside, Cumbria, United Kingdom) or a mutant thereof which retains the ability to infect sea lice, especially of the species Lepeophtheirus salmonis

14. A protozoan isolatable from sea lice which is capable of infecting sea lice for use in preventing or controlling a sea louse infestation.

15. A protozoan according to claim 13 for use in preventing or controlling a sea louse infestation.

16. A virus isolatable from sea lice which is capable of infecting sea lice for use in preventing or controlling a sea louse infestation.

17. A bacterium isolatable from sea lice which is capable of infecting sea lice for use in preventing or controlling a sea louse infestation.

18. A biological control agent comprising a microbiological agent as described in any one of claims 13 to 17.

19. A biological control agent according to claim 18 which is in the form of a dry powder, liquid, gel, paste or solid.

20. A biological control agent according to claim 18 which is in a slow release form, optionally in a microencapsulated form.

21. A cell line or culture system derived from a sea louse homogenate suitable for use in the analysis or production of viruses capable of exerting biological control of sea lice.

22. The use of coelomic fluid from crustaceans as a supplement for a cell line or culture system derived from sea louse homogenates.

23. A bioreactor system using cells cultured from sea lice used for the production of viruses capable of exerting biological control of sea lice.

24. A method of screening for viral agents capable of exerting biological control of sea lice, comprising:
(a) providing a cell line or culture system according to claim 21;
(b) adding a potential viral agent to said cell line or culture system;
(c) monitoring said cell line or culture system for evidence of infection, pathogenicity or cell death.

25. A method of producing a viral agent capable of exerting biological control of sea lice, comprising
(a) providing a cell line or culture system according to claim 21;
(b) adding a viral agent capable of exerting biological control of sea lice to said cell line or culture system under conditions which allow the replication of the virus;
(c) harvesting the viral particles so produced in step (b).

26. A method according to claim 24 or 25 further comprising the step of formulating said viral agent as a biological control agent.

27. A method of screening for biological agents capable of exerting biological control of sea lice, comprising:
(a) exposing sea louse larvae to a potential biological agent under hypertonic conditions; and
(b) monitoring said larvae for evidence of infection, morbidity and/or mortality.

28. A method according to claim 27 wherein said sea louse larvae are copepodids.

29. A method according to claim 28 wherein said larvae are exposed at between 4 and 5 days after molting into the copepodid stage.

30. A method according to any one of claims 27 to 29 wherein said larvae are exposed at 6.4% NaCl.

31. A method according to any one of claims 27 to 30 further comprising the step of formulating said biological agent as a biological control agent.

32. A method of treating or preventing sea louse infection comprising applying a microbiological agent other than a fungus at or proximal to a site of sea louse infestation.

33. A method according to claim 32 wherein the microbiological agent is selected from the agents described in claims 12 to 16.
